(19) United States
(12) Patent Application Publication
(10) Pub. No.: US 2015/0154248 A1
(43) Pub. Date: Jun. 4, 2015

(54) REPRESENTING MULTIDIMENSIONALITY OF A DATA TABLE

(71) Applicant: INTERNATIONAL BUSINESS MACHINES CORPORATION, Armonk, NY (US)

(72) Inventors: Yu Hua Deng, Beijing (CN); Shao Fei Wang, Beijing (CN); Chun Mei Yu, Beijing (CN); Qing Yu, Beijing (CN); Ying Wei Zhao, Beijing (CN)

(21) Appl. No.: 14/521,881

(22) Filed: Oct. 23, 2014

(30) Foreign Application Priority Data
Nov. 29, 2013 (CN) 201310631510.4

(51) Int. Cl. G06F 17/30; G06F 3/0482

(52) U.S. Cl. CPC G06F 17/30386; G06F 17/30592; G06F 3/0482; G06F 17/30699

(57) ABSTRACT

A method and associated systems for representing multidimensionality of a data table by combining a first set of data elements, units, or cells of the table into a multidimensional, expandable, second data unit. One or more processors of a computer system: determine a set of a first data units to be combined; determine a type of multidimensionality of the second data unit after combination; and combine, as a function of the type of multidimensionality, the first set of the first data units into the second data unit. The type of multidimensionality may be horizontal, vertical, or higher-dimensional (that is, greater than two-dimensional) dimensionality.

### TECHNICAL FIELD

The present invention relates to methods, program products, systems, and processes for representing multidimensional data in a data table.

### BACKGROUND

Information displayed in a data table, such as a worksheet, database table, or chart, may be stored and presented as a fixed number of rows and columns. Such a static two-dimensional representation may comprise redundant or empty cells that waste storage space and require additional screen area for display. In some cases, this problem may even prevent users from being able to simultaneously display all the cells necessary to perform a desired operation.

### BRIEF SUMMARY

A first embodiment of the present invention provides a method for representing multidimensionality of a data table, comprising:

one or more processors of a computer system determining a set of a first data units to be combined;

the one or more processors further determining type of multidimension of a second data unit after combination;

the one or more processors combining, in accordance with the type of multidimension, the set of the first data units to generate the second data unit for providing optional multidimensional data presentation based on the type of multidimension,

wherein the type of multidimension includes at least one of horizontal multidimension, vertical multidimension and performing multidimension according to a dimensionality other than two-dimensional dimensionality.

A second embodiment of the present invention system for representing multidimensionality of a data table, comprising:

a first determination apparatus configured to determine a set of a first data units to be combined;

a second determination apparatus configured to determine type of multidimension of a second data unit after combination;

a multidimensional apparatus configured to combine, in accordance with the type of multidimension, the set of the first data units to generate the second data unit for providing optional multidimensional data presentation based on the type of multidimension,

wherein the type of multidimension includes at least one of horizontal multidimension, vertical multidimension and performing multidimension according to a dimensionality other than two-dimensional dimensionality.

### BRIEF DESCRIPTION OF THE DRAWINGS

FIG. 1 shows the structure of a computer system and computer program code that may be used to implement a method for representing multidimensionality of a data table in accordance with embodiments of the present invention.

FIG. 2 shows a flowchart of a method for representing multidimensionality of a data table according to an embodiment of the present invention;

FIGS. 3A, 3B, and 3C show schematic diagrams of a procedure for representing horizontal multidimensionality of a two dimensional data table according to an embodiment of the present invention;

FIGS. 4A, 4B, and 4D show schematic diagrams of a procedure of further representing horizontal multidimensionality of the data table of FIG. 3 in accordance with a relationship between cells of the table, according to an embodiment of the present invention;

FIG. 5 shows a schematic diagram of newly creating multidimensional data table according to an embodiment of the present invention;

FIGS. 6A and 6B show a schematic diagram for expanding a multidimensional data table according to an embodiment of the present invention.

FIG. 7 shows a block diagram of a system for representing multidimensionality of a data table according to an embodiment of the present invention.

### DETAILED DESCRIPTION

Information displayed in a data table, such as a worksheet, database table, or chart, may be stored and presented as a fixed number of rows and columns. Such a static representation may comprise redundant or empty cells that waste storage space and require additional screen area for display. In some cases, this problem may even prevent users from being able to simultaneously display all the cells necessary to perform a desired operation.

Consider, for example, a two-dimensional data table that represents a time sheet for four part-time workers:

TABLE 1

| NAME | Mon | Tue | Wed | Thu | Fri | Total |
|---|---|---|---|---|---|---|
| John | 2 | 3 | | 5 | | 8 |
| Mary | | | 4 | 4 | | 8 |
| Helen | 2 | 1 | 5 | | 8 | 16 |
| Steve | 1 | 1 | 3 | 5 | | 10 |

Here, it can be seen that the table contains empty, wasted cells whenever a worker does not report time for a particular day. Thus, there are at seven wasted or redundant cells in this Table 1. In real-world cases wherein a table may contain hundreds of rows or columns, the redundant cells may cause serious problems of wasted storage space.

In prior art, there exists a technical solution to this problem by using “data filtering” by way of a drop-down menu. For example, in Table 1, such a technical solution might comprise hiding the four time-entry rows and adding a drop-down menu to the “NAME” column of Table 1 that lets a user reveal each row. If, for example, the drop-down menu displayed choices “John,” “Mary,” “Helen,” and “Steve,” a user could select “John” from the menu in order to display the row showing John's time entries.

Such data-filtering solutions fail to solve the problem of redundant cells and merely mask rows of the data table. If a number of columns in a table is sufficiently large, after data filtering is performed by use of the drop-down menu, drag or scroll may still be needed to display columns of the “John” row that are positioned outside of the screen display range.

These issues become far more complex in data structures that represent data in more than two dimensions, such as a multidimensional array or an array of n-tuples. In such cases, it may be impossible to view all elements of a contiguous set of data elements (or “dataset”) of the data structure, especially when the dataset comprises data elements organized into more than two dimensions. Examples herein will generally describe embodiments that comprise two-dimensional representations, but these examples should not be construed to limit embodiments to two-dimensional data structures.

Considering the above existing problems, one of objects of the present invention is to provide a method for representing data elements of a multidimensional data table so as to eliminate redundant cells. Another object of the present invention is to provide a method for avoiding an unnecessary display of excess rows or columns that may make it more efficient or less cumbersome to view or manipulate the data table.

In descriptions herein, we generally use the term “data unit” to identify a distinct element of data, such as a text string, a table entry, or a worksheet cell. This should not be construed to limit embodiments of the present invention. Examples that comprise references to cells of a two-dimensional spreadsheet worksheet should not be construed to limit embodiments of the present invention to worksheets or to two-dimensional data structures.

In descriptions herein, we apply the term “multidimensionality” to a data unit or cell to mean that the data unit or cell represents data that may be represented by an n-dimensional data structure. Two-dimensional multidimensionality, for example, implies data that may be represented as one or more rows and columns of a two-dimensional data structure, such as a two-dimensional table or worksheet. In its simplest form, a multidimensional data unit or cell characterized by horizontal multidimensionality means that the cell may be expanded to represent a horizontal row of data units or cells. Similarly, a multidimensional data unit or cell characterized by vertical multidimensionality means that the cell may be expanded to represent a vertical column of data units or cells.

Embodiments of the present invention may be applied to data structures that have greater than two-dimensional dimensionality, such as an array of 3-tuples, or a two-dimensional table that comprises cells that each, in turn, comprise an n-tuple data structure. Multidimensional data units that represent sets of data units of such higher-dimensional data structures may themselves be characterized as having “higher-level” multidimensionality.

By convention, data units or cells of a conventional two-dimensional table or worksheet are not considered multidimensional because each such data unit or cell contains a single element of data. When a set of such cells or units are combined into and represented by a single cell or unit, we refer to that single cell or unit as being multidimensional, for reasons described above.

In some cases, multidimensional data units or cells may be nested, optionally by means of multiple applications of an embodiment of the present invention. In such cases, the level of multidimensionality of the nested cell may be identified as a function, such as a sum or product, of the multidimensionality of each nested level of data structure comprised by the nested unit or cell. In one example, a multidimensional cell might comprise a first row of cells, each cell of the first row of cells might comprise a column of cells, and each cell of the column of cells might comprise a second row of cells.

According to one aspect of the invention, there is provided a method for representing multidimensionality of a data table, comprising: determining a set of a first data units to be combined; determining type of multidimension of a second data unit after combination; combining, in accordance with the type of multidimension, the set of the first data units to generate the second data unit for providing optional multidimensional data presentation based on the type of multidimension, wherein the type of multidimension includes at least one of horizontal multidimension, vertical multiple dimension and performing multidimension according to a dimensionality other than two-dimensional dimensionality.

According to another aspect of the invention, there is provided a computer program product for multidimension of a data table, comprising: a first determination apparatus configured to determine a set of a first data units to be combined; a second determination apparatus configured to determine type of multidimension of a second data unit after combination; a multidimensional apparatus configured to combine, in accordance with the type of multidimension, the set of the first data units to generate the second data unit for providing optional multidimensional data presentation based on the type of multidimension, wherein the type of multidimension includes at least one of horizontal multidimension, vertical multidimension and performing multidimension according to a dimensionality other than two-dimensional dimensionality.

According to another aspect of the invention, there is provided a system for multidimension of a data table, comprising: a first determination apparatus configured to determine a set of a first data units to be combined; a second determination apparatus configured to determine type of multidimension of a second data unit after combination; a multidimensional apparatus configured to combine, in accordance with the type of multidimension, the set of the first data units to generate the second data unit for providing optional multidimensional data presentation based on the type of multidimension, wherein the type of multidimension includes at least one of horizontal multidimension, vertical multidimension and performing multidimension according to a dimensionality other than two-dimensional dimensionality.

The method or system provided according to the present invention can eliminate redundant cells and avoid excessive rows or columns to improve user's experience when the user uses the data table.

Some preferable embodiments will be described in more detail with reference to the accompanying drawings, in which the preferable embodiments of the present disclosure have been illustrated. However, the present disclosure can be implemented in various manners, and thus should not be construed to be limited to the embodiments disclosed herein. On the contrary, those embodiments are provided for the thorough and complete understanding of the present disclosure, and completely conveying the scope of the present disclosure to those skilled in the art.

As will be appreciated by those skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.”

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

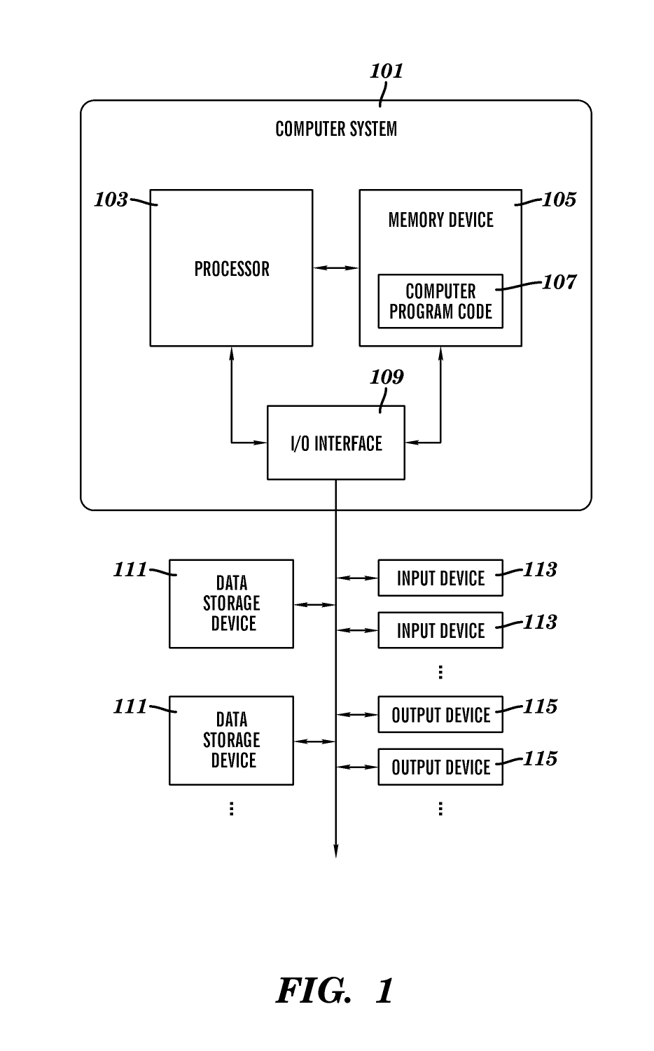

FIG. 1 shows a structure of a computer system and computer program code that may be used to implement a method for representing multidimensionality of a data table in accordance with embodiments of the present invention. FIG. 1 refers to objects 101-115.

In FIG. 1, computer system 101 comprises a processor 103 coupled through one or more I/O Interfaces 109 to one or more hardware data storage devices 111 and one or more I/O devices 113 and 115.

Hardware data storage devices 111 may include, but are not limited to, magnetic tape drives, fixed or removable hard disks, optical discs, storage-equipped mobile devices, and solid-state random-access or read-only storage devices. I/O devices may comprise, but are not limited to: input devices 113, such as keyboards, scanners, handheld telecommunications devices, touch-sensitive displays, tablets, biometric readers, joysticks, trackballs, or computer mice; and output devices 115, which may comprise, but are not limited to printers, plotters, tablets, mobile telephones, displays, or sound-producing devices. Data storage devices 111, input devices 113, and output devices 115 may be located either locally or at remote sites from which they are connected to I/O Interface 109 through a network interface.

Processor 103 may also be connected to one or more memory devices 105, which may include, but are not limited to, Dynamic RAM (DRAM), Static RAM (SRAM), Programmable Read-Only Memory (PROM), Field-Programmable Gate Arrays (FPGA), Secure Digital memory cards, SIM cards, or other types of memory devices.

At least one memory device 105 contains stored computer program code 107, which is a computer program that comprises computer-executable instructions. The stored computer program code includes a program that implements a method for representing multidimensionality of a data table in accordance with embodiments of the present invention, and may implement other embodiments described in this specification, including the methods illustrated in FIGS. 1-7. The data storage devices 111 may store the computer program code 107. Computer program code 107 stored in the storage devices 111 is configured to be executed by processor 103 via the memory devices 105. Processor 103 executes the stored computer program code 107.

Thus the present invention discloses a process for supporting computer infrastructure, integrating, hosting, maintaining, and deploying computer-readable code into the computer system 101, wherein the code in combination with the computer system 101 is capable of performing a method for representing multidimensionality of a data table.

Any of the components of the present invention could be created, integrated, hosted, maintained, deployed, managed, serviced, supported, etc. by a service provider who offers to facilitate a method for representing multidimensionality of a data table. Thus the present invention discloses a process for deploying or integrating computing infrastructure, comprising integrating computer-readable code into the computer system 101, wherein the code in combination with the computer system 101 is capable of performing a method for representing multidimensionality of a data table.

One or more data storage units 111 (or one or more additional memory devices not shown in FIG. 1) may be used as a computer-readable hardware storage device having a computer-readable program embodied therein and/or having other data stored therein, wherein the computer-readable program comprises stored computer program code 107. Generally, a computer program product (or, alternatively, an article of manufacture) of computer system 101 may comprise said computer-readable hardware storage device.

While it is understood that program code 107 for cross-retail marketing based on analytics of multichannel clickstream data may be deployed by manually loading the program code 107 directly into client, server, and proxy computers (not shown) by loading the program code 107 into a computer-readable storage medium (e.g., computer data storage device 111), program code 107 may also be automatically or semi-automatically deployed into computer system 101 by sending program code 107 to a central server (e.g., computer system 101) or to a group of central servers. Program code 107 may then be downloaded into client computers (not shown) that will execute program code 107.

Alternatively, program code 107 may be sent directly to the client computer via e-mail. Program code 107 may then either be detached to a directory on the client computer or loaded into a directory on the client computer by an e-mail option that selects a program that detaches program code 107 into the directory.

Another alternative is to send program code 107 directly to a directory on the client computer hard drive. If proxy servers are configured, the process selects the proxy server code, determines on which computers to place the proxy servers' code, transmits the proxy server code, and then installs the proxy server code on the proxy computer. Program code 107 is then transmitted to the proxy server and stored on the proxy server.

In one embodiment, program code 107 for cross-retail marketing based on analytics of multichannel clickstream data is integrated into a client, server and network environment by providing for program code 107 to coexist with software applications (not shown), operating systems (not shown) and network operating systems software (not shown) and then installing program code 107 on the clients and servers in the environment where program code 107 will function.

The first step of the aforementioned integration of code included in program code 107 is to identify any software on the clients and servers, including the network operating system (not shown), where program code 107 will be deployed that are required by program code 107 or that work in conjunction with program code 107. This identified software includes the network operating system, where the network operating system comprises software that enhances a basic operating system by adding networking features. Next, the software applications and version numbers are identified and compared to a list of software applications and correct version numbers that have been tested to work with program code 107. A software application that is missing or that does not match a correct version number is upgraded to the correct version.

A program instruction that passes parameters from program code 107 to a software application is checked to ensure that the instruction's parameter list matches a parameter list required by the program code 107. Conversely, a parameter passed by the software application to program code 107 is checked to ensure that the parameter matches a parameter required by program code 107. The client and server operating systems, including the network operating systems, are identified and compared to a list of operating systems, version numbers, and network software programs that have been tested to work with program code 107. An operating system, version number, or network software program that does not match an entry of the list of tested operating systems and version numbers is upgraded to the listed level on the client computers and upgraded to the listed level on the server computers.

After ensuring that the software, where program code 107 is to be deployed, is at a correct version level that has been tested to work with program code 107, the integration is completed by installing program code 107 on the clients and servers.

Embodiments of the present invention may be implemented as a method performed by a processor of a computer system, as a computer program product, as a computer system, or as a processor-performed process or service for supporting computer infrastructure.

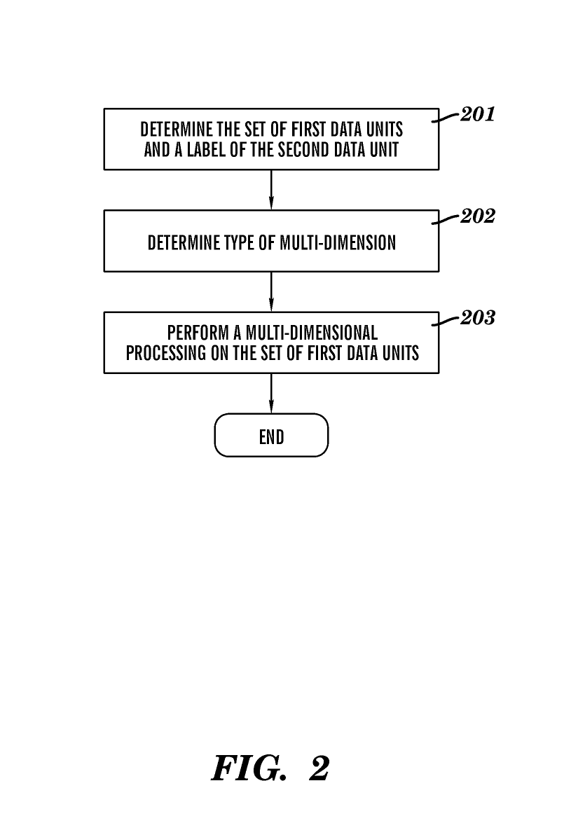

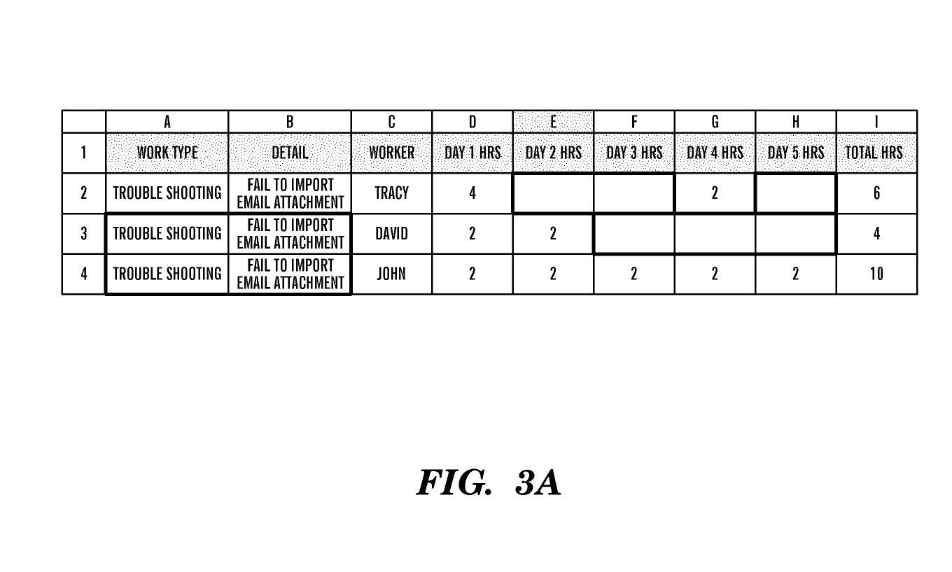

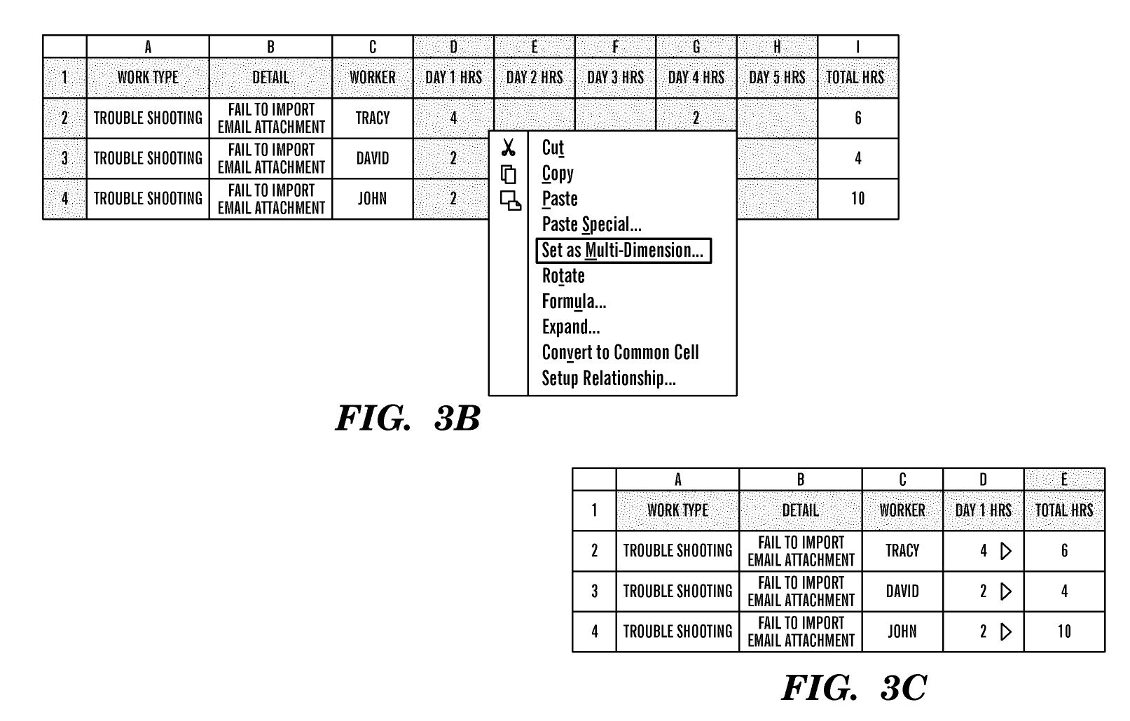

Hereinafter, FIG. 2 is described in conjunction with specific examples of FIGS. 3 to 6. FIG. 2 shows a flowchart of a method for representing multidimensionality of a data table according to an embodiment of the invention.

The method shown in FIG. 2 begins with step 201 in which a first data-unit set to be combined is determined. According to one embodiment of the invention, in a case of performing process for the existing data table, the first data-unit set includes a plurality of cells of the existing two-dimensional data table.

The example of FIG. 3A shows an existing two-dimensional data table. As can be seen, there are several redundant cells in the two-dimensional data table shown in FIG. 3A. Columns D, E, F, G, and H of FIG. 3A represent time billed on each day of the first to fifth day, and column I represents total time for the week.

In FIG. 3B, all the cells of columns D, E, F, G, and H are identified as a first data-unit set to be combined. According to one embodiment of the invention, the first data-unit set to be combined is determined in response to a user's selection of data units (or, here, cells). According to another embodiment of the invention, the first data-unit set to be combined is determined in response to determining a data column with a specific name in advance. According to one embodiment of the invention, in step 201, in addition to determining the first data-unit set to be combined, a label of a second data unit formed by combining the cells or units of the first data-unit set must also be determined. Since the second data unit formed after combination does not exist in the original two-dimensional data table, a new label has to be given thereto.

With reference to FIG. 3C, the label of the combined second data unit is determined to be “DAY 1 HRS” (data column D). It should be pointed out that, determining the label of the second data unit is not an essential step for implementing the concept of the invention, since in some cases, the original label in the data table may be used as the label of the second data unit as necessary without additionally determining a new label of the second data unit.

Hereinafter, the method shown in FIG. 2 goes to step 202 in which a multidimension “type” of the combined second data unit is determined. According to one embodiment of the invention, the multidimension type may be a “horizontal” (row-wise) multidimension or “first-dimension” multidimension that can be comprehended as the first data-unit set being reduced along the horizontal direction. According to another embodiment of the invention, the multidimension type may be a “vertical” (column-wise) multidimension or “second-dimension” multidimension that can be comprehended as the first data-unit set being reduced along the vertical direction.

According to still another embodiment, the horizontal multidimension and the vertical multidimension may be overlapped or combined and, for example, the horizontal multidimensioning is firstly performed on a first data-unit set and then the vertical multidimensioning is performed on the resulting second data-unit set, or the vertical multidimension is firstly performed on a first data-unit set and then the horizontal multidimension is performed on the resulting second data-unit set.

Taking FIG. 3B as an example, it is assumed that after the first data-unit set to be combined is determined in FIG. 3B, it is further determined in step 202 that the multidimension type of the first data set is a horizontal multidimension. After that, the method shown in FIG. 2 continues with step 203.

In step 203, in accordance with the multidimension type identified in step 201, data units (cells) comprised by the first data-unit set are combined to generate a second data unit that is used to provide an optional multidimensional data presentation based on the multidimension type.

FIG. 3C shows the second (multidimensional) data unit generated by combining the determined first data-unit set in the horizontal multidimension. According to one embodiment of the invention, the second data unit is an expandable, multidimensional cell generated by combining the data units (that is, the cells) of the first data-unit set.

According to still another embodiment, the second data unit is a group of cells generated by combining the first data-unit set. Each of the cells of data column D in FIG. 3C belongs to the second data unit, that is, the second data unit of FIG. 3C comprises a group of three cells. Since the second data unit is generated from combining the first data-unit set in accordance with the determined multidimension type, the second data unit can provide the optional multidimensional data presentation based on the multidimension type. As shown in FIG. 3C, in each of the cells of the second data unit, an expansion symbol (here, a triangle) is displayed, and when a user clicks the triangle symbol, the data recorded in the original first data-unit set will be presented in sequence. That is, the data dimensionality presented by the second data unit is switched in response to receiving a request to switch the data dimensionality presented by the second data unit.

For example, when a user clicks the triangle symbol of column D of data row 2 (labeled“Tracy”), the data values presented in sequence are “4, 2”, as shown in FIG. 3B as being populated data cells of the “Tracy” row.

It should be pointed out that the triangle symbol in FIG. 3C is only an illustrative symbol, and those skilled in the art can employ any other types of symbol, mark (such as an arrow) to provide this optional multidimensional data presentation.

Although only the example of combining the first cell set based on the two multidimension types (horizontal and the vertical) is shown in FIG. 3, the concept of the invention is not limited thereto. If, for example, the multidimension data information is represented by a plurality of data tables, or is represented by a higher-dimensional data structure, such as a cube or an n-dimensional array (n>2), an embodiment of the present invention may perform the multidimensional process described above to combine a first cell set into a second cell by means of a multidimensionality type beyond a dimensionality of two-dimension of horizontal and vertical. Likewise, a multidimension type that comprises greater than two dimensions may be combined with a horizontal or vertical multidimension type.

As can be seen through the method shown in the above FIG. 2 and with reference to the specific example of FIGS. 3A to 3C, the redundant cells of the two-dimensional data table are eliminated by the multidimension process, and the width presented by the table is reduced, so that the wasted storage space is decreased and the user's experience of usage of data table is improved. In a case where data amount is large and number of redundant cells is great, the above advantages will be more prominent.

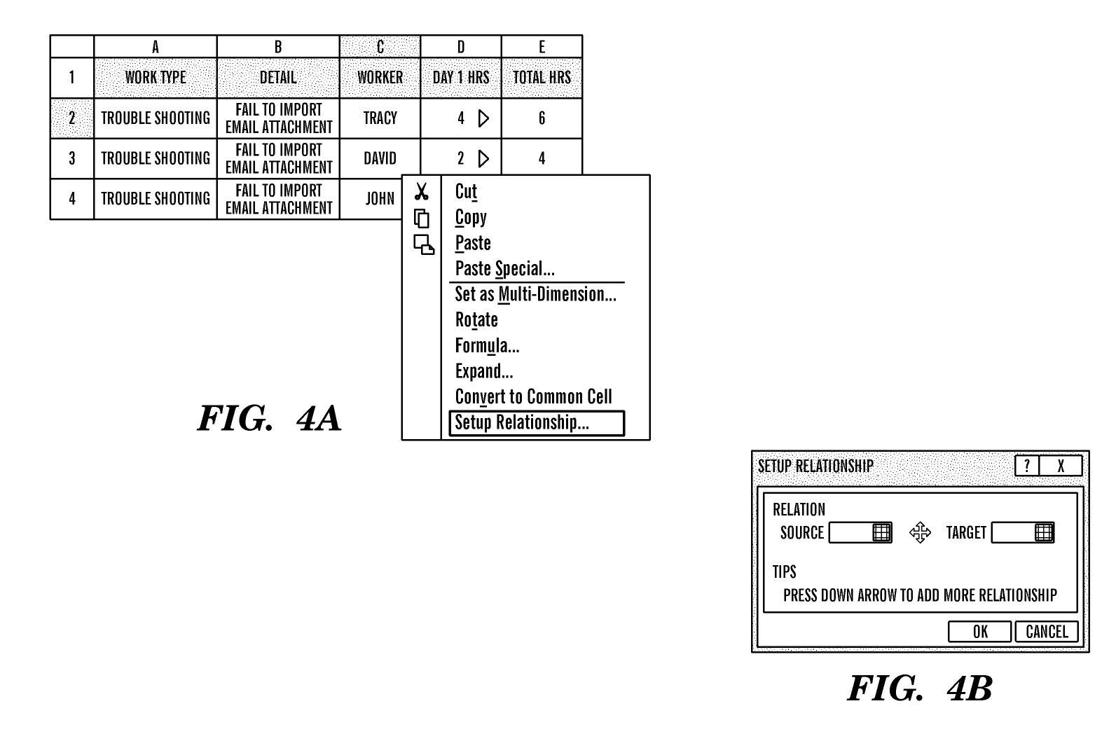

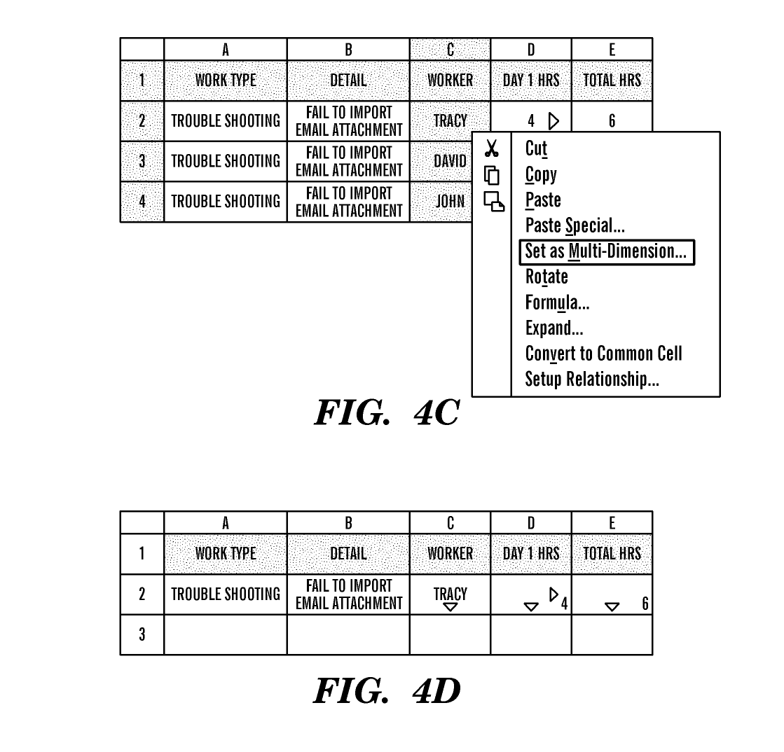

FIGS. 3A to 3C show an embodiment of the present invention that performs the multidimension process on a first data-unit set according to single horizontal dimensionality. In fact, according to one embodiment of the invention, it is possible to perform the multidimension process on this data table on the basis of multidimension process result of FIG. 3C, as shown in FIGS. 4A to 4D.

FIG. 4C shows a method of further determining, on the basis of the data table generated by the horizontal dimensionality multidimension process of FIG. 3C, that three cells of data column C (respectively Tracy, David, John) are the first data-unit set to be combined in step 201, and then determining that the label of the second data unit after the first data-unit set is combined is still “Owner”. Then it is determined that the combination is performed on the first data-unit set in accordance with the multidimension type of vertical dimensionality (as in step 202).

Further, the second data unit shown in FIG. 4D is generated and presented as a new data column C, which comprises one cell labeled “Tracy” (step 203).

In the second data unit of “Tracy”, the optional multidimensional data presentation based on a multidimension type of a vertical dimensionality is provided through a downward triangular symbol. That is, in response to receiving a request to switch the data dimensionality presented by the second data unit, the data dimensionality presented by the second data unit is switched.

For example, in response to a user's click on the triangular symbol in the second data unit of “Tracy”, the data dimensionality presented by the second data unit (David, John, and Tracy) are switched in sequence. As can be seen in FIG. 4D, after having been successively processed twice (in both the horizontal multidimension and the vertical multidimension), the original conventional two-dimensional data table (shown in FIG. 3A) changes into a data table with one row and five columns, as shown in FIG. 4D. It should be pointed out that, a plurality of multidimension processes are preferred embodiments only in some cases, and are not essential to the present invention; and even if one multidimension type is determined and multidimension process is implemented once, it is also possible to realize the technical object and effect of the invention.

It should be pointed out herein that, in some cases (such as in the example of FIG. 4D), if we apply the multidimension process in only the vertical dimensionality on the data column C, when a user clicks on the symbol of the switching dimensionality in the second data unit after the performance of the multidimension process of data column C, the user can be switched to, for example, David; but the other data columns the data table still present data content corresponding to Tracy.

Taking FIG. 4D as example, if the presentation dimensionality of the data column C is switched from Tracy to David, a mistake will occur if the data value of 4 is still presented in the data column D. That is, in some cases, different data rows or columns may be associated therewith and have specific binding relationships. In some embodiments, in order to still reflect this binding relationship at a time of a switch of the data dimensionality presentation and to be capable of correspondingly switching to presentation dimensionality of other second data units automatically at the time of switch presentation dimensionality of a second data unit, the method shown in FIG. 2 further includes: determining an associated relationship between the first data-unit set and other data units, and then changing data presented by the other data unit in an associated way in response to a change in the data dimensionality presented by the second data unit.

In another embodiment of the invention, determining that there is an associated relationship between the first data-unit set and other data units includes: determining the first data-unit set is a source data unit, and determining an object data unit associated with the source data unit. This can be more obviously seen from the examples of FIGS. 4A and 4B.

As shown in FIGS. 4A and 4B, the data column C (the first data-unit set) is determined to be a “source” data unit, and data columns D and E (the other data units) are determined to be the “object” or “target” data unit associated with data column C. Here, the example of FIG. 4B shows an embodiment of a step of setting a type of user interface of the associated relationship, and those skilled in the art may employ other modes to set this kind of associated relationship on the basis of comprehending the concept of the invention.

After it is determined from FIGS. 4A and 4B that there is an associated relationship between the first data-unit set (column C) and other data units (columns D and E), in FIG. 4D, Tracy is switched to David in response to the data dimensionality presented by data column C (the second data unit on which the multidimension process is performed in accordance with the vertical dimensionality), the data dimensionality presented in the data column D is switched to 2 in associated way, and the data dimensionality presented in the data column E is switched to 4 in associated way, so as to ensure the correctness of data presentation.

It should be emphasized that, although the process of determining the associated relationship between the first data unit and other data units as shown in FIGS. 4A and 4B occurs before a practical multidimension process is performed in FIGS. 4C and 4D, this should not be interpreted as implying a strict limitation on time sequence.

According to still another embodiment of the invention, it is possible to first perform one kind of multidimension process on a first data-unit set, and then to determine a associated relationship between the first data-unit set and other data units.

The respective steps of the method shown in FIG. 2 do not have a strict limited time-sequence relationship. For example, it is possible to perform step 202 of determining a multidimension type of a combined second data unit, and then to perform step 201 of determining the first data-unit set to be combined and the label of the combined second data unit.

In one embodiment of the invention, in order to restore the original conventional two-dimensional data table or generate the two-dimensional data table, an expansion operation can be performed on the multidimensional data table after being subjected to the multidimension process. That is, in response to receiving a request to expand the multidimensional second data unit, the second data unit is expanded to the first data-unit set.

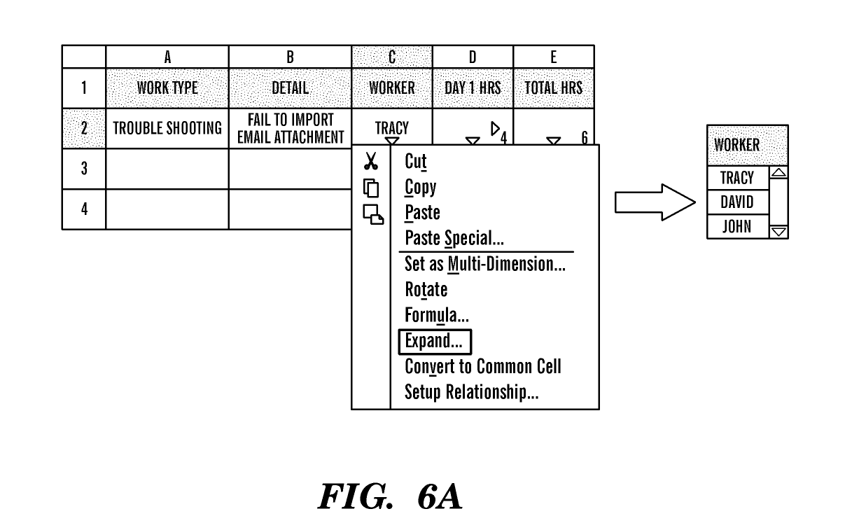

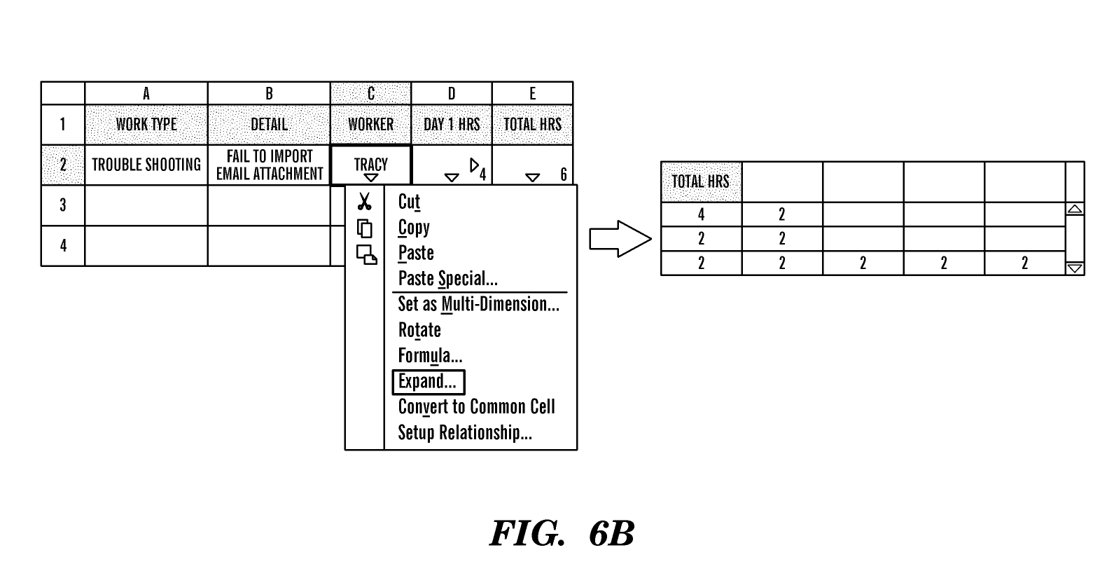

As shown in FIG. 6A, with a command of “Expand”, the data column C (the second data unit generated from the vertical multidimension process) is expanded to the first data-unit set on the right side in accordance with the vertical dimensionality.

In the example of FIG. 6B, on the basis of expanding based on the vertical dimensionality of FIG. 6A, expansion is further performed based on horizontal dimensionality, so as to restore the two-dimensional data table shown on the right side of FIG. 6B. Those skilled in the art understand that, in some embodiments, such an expansion may be performed in a hierarchical manner, first expanding according to a first kind of dimensionality, and then expanding according to a second kind of dimensionality.

The implementation of the Expand command shown in FIGS. 6A and 6B is shown only for illustrative purposes, and many other methods of implementing an expansion command, as may be known in the art, may be employed. For example, a user may input an Expand command by double-clicking a second data unit, and thus expanding the second data unit into the first data-unit set.

In a further embodiment, a multidimensionality data label may be utilized to uniquely identify either or both of the data currently presented and the not currently presented in the second data unit. In a conventional two-dimensional data-table mode, marking a cell may be expressed as, for example, a designation of the form “C2,” the meaning of which is a cell positioned in column C and row 2. But in a data table that has been subjected to the multidimension process, this marking manner is not sufficient to identify a specific position and dimensionality of a cell.

In FIG. 4D, for example, if D2 is used to identify a cell, although the data value currently presented in column D and row 2 is the value 4, since there are other values of both horizontal dimensionality and vertical dimensionality therein, a representation in a form similar to “D2V1H1” may be used to identify the specific data dimensionality in a cell. Here, “D2V1H1” might refer to a specific data value located at the vertical dimensionality 1 and horizontal dimensionality 1 of column D and row 2. This manner of identifying specific data dimensionality within the multidimensional data table may be further applied to operations in the table, such as a worksheet's computational formulas.

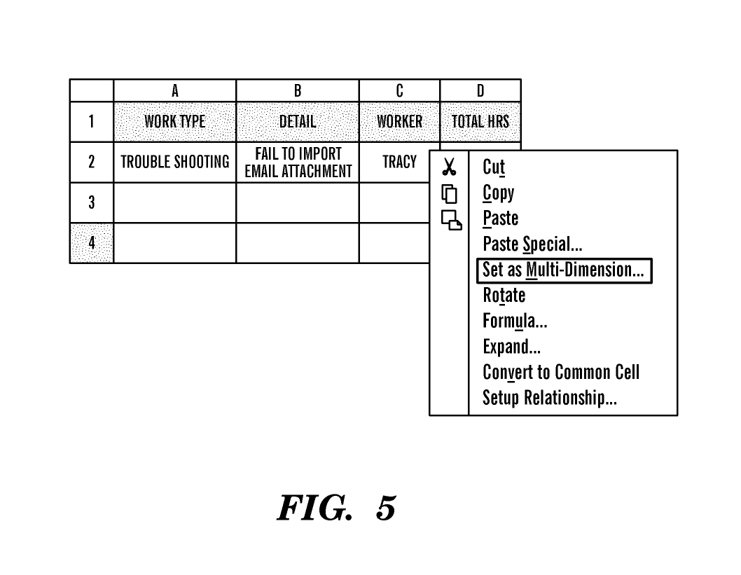

Although the examples of FIGS. 2-3C show multidimension processes performed on an existing conventional two-dimensional data table, other embodiments may be implemented on other types of data structures, such as a new data table in which the multidimension is directly constructed, as shown in FIG. 5. In this example, data column C may have been specified as a multidimension data column when creating the data table, and then the multidimension type of data column C (horizontal or vertical) and the specific values of each multidimension of data column C are further determined. In such embodiments, wherein a data table is created as a multidimensional data table, the method of FIG. 2 may be also applicable. Here, in step 201, the newly created multidimension data unit in the data table might itself be deemed to be a second data unit and, although the first data-unit set may not be expressly represented in the table, the first data-unit set must have been logically determined and the values of the first data-unit set must have been entered when the multidimensional table was created.

The embodiments described above have been described with reference to the appended figures. It is known to those skilled in the art that these and other embodiments of the present invention may be implemented in software or in hardware, or in a combination of software and hardware.

It is further known to those skilled in the art that, by implementing the respective steps of the above method in software, hardware, or a combination thereof, a system for representing multidimensionality of a data table in accordance with the present invention may be provided. Such embodiments may comprise several apparatuses or modules configured to perform corresponding steps. Those skilled in the art can understand how to write a program to achieve operations executed by the apparatus and module through reading the specification. Since the system and the method are based on the same inventive concept, the same or corresponding implementation details mayalso be applied to an apparatus corresponding to the above method, and since it has been fully and entirely described above, it will no longer be repeatedly described hereinafter for purposes of readability.

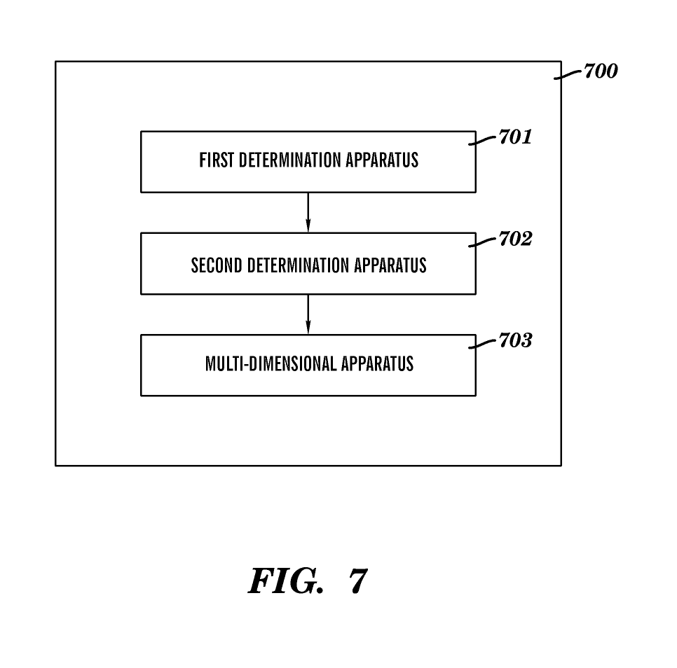

FIG. 7 shows a block diagram of a system 700 for representing multidimensionality of a data table in accordance with embodiments of the present invention. The system 700 includes a first determination apparatus 701 configured to determine a first data-unit set to be combined and to further determine a label of the combined second data unit. Aa second determination apparatus 702 is configured to determine a multidimension type of the combined second data unit. A multidimension apparatus 703 is configured to combine the first data-unit set to generate the second data unit in accordance with the multidimension type, such that the second data unit may provide an optional multidimension data presentation based on the multidimension type. Here, the multidimension type may include at least one of a horizontal multidimension, a vertical multidimension, and a multidimensionality greater than or other than two-dimensional dimensionality. Because the apparatuses 701 to 703 of the system shown in FIG. 7 correspond to steps 201 to 203 of the method shown in FIG. 2, the description thereof will not be repeated herein.

In other embodiments of the present invention, the system 700 further comprises a third determination apparatus configured to determine whether there is an associated relationship between the first data-unit set and the other data units, and may further comprise an associated apparatus configured to change the data presented by the other data units in associated way in response to change in data dimensionality presented by the second data unit.

According to another embodiment of the invention, the third determination apparatus in system 700 is configured to determine that the first data-unit set is a source data unit, and determine a target data unit associated with the source data unit.

In another embodiment of the invention, the system 700 further includes a switch apparatus configured to switch the data dimensionality presented by second data unit in response to receiving a request of switching the data dimensionality presented by the second data unit.

According to yet another embodiment of the invention, the system 700 further includes an expansion apparatus configured to expand the second data unit to the first data-unit set in response to receiving a request of expanding the multidimensional second data unit.

In another embodiment of the invention, the system 700 further includes an identification apparatus configured to uniquely identify, with a label of the multidimensional data, currently presented data and data that is not currently presented in the second data unit.

According to still another embodiment of the invention, the system 700 further includes a fourth determination apparatus configured to determine a label of combined second data unit.

In such embodiments, the third determination apparatus, the switching apparatus, the expansion apparatus, the identification apparatus and the fourth determination apparatus may respectively correspond to steps added to the process described in FIG. 2 in conjunction with FIGS. 3A-6B.

The flowcharts and block diagrams of FIGS. 1-7 illustrate the architecture, functionality, and operation of possible implementations of systems, methods, and computer program products according to embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Furthermore, each block of the block diagrams and/or flowchart illustrations, and combinations of such blocks, may be implemented by special-purpose hardware-based systems that perform specified functions or operations, or that perform combinations of special purpose hardware and computer instructions.

Descriptions of the various embodiments of the present invention have been presented here for purposes of illustration, but are not intended to be exhaustive or to limit the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While particular embodiments of the present invention have been described herein for purposes of illustration, many modifications and changes will become apparent to those skilled in the art. Accordingly, the appended claims are intended to encompass all such modifications and changes as fall within the true spirit and scope of this invention.

1-17. (canceled)

18. A method for representing multidimensionality of a data table, wherein the data table comprises a set of data cells, the method comprising:
one or more processors of a computer system selecting a first subset of the set of data cells;
the one or more processors defining a second data cell that is not comprised by the set of data cells;
the one or more processors determining a type of multidimensionality of the second data cell, wherein the type of multidimensionality is a function of an internal arrangement of data cells of the first subset of data cells;
the one or more processors configuring the second data cell to represent the first subset of data cells as a single multidimensional cell, wherein the configuring is performed as a function of the type of multidimensionality;
the one or more processors replacing the first subset of data cells in the data table with the second data cell, such that the second data cell may be interactively expanded by a user into the first subset of data cells.

19. The method of claim 18, wherein the type of multidimensionality includes at least one of: horizontal multidimensionality, vertical multidimensionality, and a higher-level dimensionality, wherein the higher-level dimensionality identifies that the first subset of data cells is represented in the data table in an arrangement of more than one dimension.

20. The method of claim 18, wherein the second data cell is associated with horizontal multidimensionality and is capable of being expanded into a full or partial row of the data table, and wherein the full or partial row is comprised by the first subset.

21. The method of claim 18, wherein the second data cell is associated with vertical multidimensionality and is capable of being expanded into a full or partial column of the data table, and wherein the full or partial column is comprised by the first subset.

22. The method of claim 18, wherein the second data cell is associated with higher-level multidimensionality and is capable of being expanded into a data structure that comprises at least two of: a full or partial vertical column of the data table, a full or partial horizontal row of the data table, and a second subset of the set of data cells that is represented in the data table in an arrangement of more than one dimension.

23. The method of claim 18, further comprising providing at least one support service for at least one of creating, integrating, hosting, maintaining, and deploying computer-readable program code in the computer system, wherein the computer-readable program code in combination with the computer system is configured to implement the selecting, defining, determining, configuring, and replacing.

24. A computer program product, comprising a computer-readable hardware storage device having a computer-readable program code stored therein, said program code configured to be executed by one or more processors of a computer system to implement a method for representing multidimensionality of a data table, wherein the data table comprises a set of data cells, the method comprising:
the one or more processors selecting a first subset of the set of data cells;
the one or more processors defining a second data cell that is not comprised by the set of data cells;
the one or more processors determining a type of multidimensionality of the second data cell, wherein the type of multidimensionality is a function of an internal arrangement of data cells of the first subset of data cells;
the one or more processors configuring the second data cell to represent the first subset of data cells as a single multidimensional cell, wherein the configuring is performed as a function of the type of multidimensionality;
the one or more processors replacing the first subset of data cells in the data table with the second data cell, such that the second data cell may be interactively expanded by a user into the first subset of data cells.

25. The computer program product of claim 24, wherein the type of multidimensionality includes at least one of: horizontal multidimensionality, vertical multidimensionality, and a higher-level dimensionality, wherein the higher-level dimensionality identifies that the first subset of data cells is represented in the data table in an arrangement of more than one dimension.

26. The computer program product of claim 24, wherein the second data cell is associated with horizontal multidimensionality and is capable of being expanded into a full or partial row of the data table, and wherein the full or partial row is comprised by the first subset.

27. The computer program product of claim 24, wherein the second data cell is associated with vertical multidimensionality and is capable of being expanded into a full or partial column of the data table, and wherein the full or partial column is comprised by the first subset.

28. The computer program product of claim 24, wherein the second data cell is associated with higher-level multidimensionality and is capable of being expanded into a data structure that comprises at least two of: a full or partial vertical column of the data table, a full or partial horizontal row of the data table, and a second subset of the set of data cells that is represented in the data table in an arrangement of more than one dimension.

29. A computer system comprising one or more processors, a memory coupled to said processor, and a computer-readable hardware storage device coupled to said processor, said storage device containing program code configured to be run by said processor via the memory to implement a method for representing multidimensionality of a data table, wherein the data table comprises a set of data cells, the method comprising:
the one or more processors selecting a first subset of the set of data cells;
the one or more processors defining a second data cell that is not comprised by the set of data cells;
the one or more processors determining a type of multidimensionality of the second data cell, wherein the type of multidimensionality is a function of an internal arrangement of data cells of the first subset of data cells;
the one or more processors configuring the second data cell to represent the first subset of data cells as a single multidimensional cell, wherein the configuring is performed as a function of the type of multidimensionality;
the one or more processors replacing the first subset of data cells in the data table with the second data cell, such that the second data cell may be interactively expanded by a user into the first subset of data cells.

30. The computer system of claim 29, wherein the type of multidimensionality includes at least one of: horizontal multidimensionality, vertical multidimensionality, and a higher-level dimensionality, wherein the higher-level dimensionality identifies that the first subset of data cells is represented in the data table in an arrangement of more than one dimension.

31. The computer system of claim 29, wherein the second data cell is associated with horizontal multidimensionality and is capable of being expanded into a full or partial row of the data table, and wherein the full or partial row is comprised by the first subset.

32. The computer system of claim 29, wherein the second data cell is associated with vertical multidimensionality and is capable of being expanded into a full or partial column of the data table, and wherein the full or partial column is comprised by the first subset.

33. The computer system of claim 29, wherein the second data cell is associated with higher-level multidimensionality and is capable of being expanded into a data structure that comprises at least two of: a full or partial vertical column of the data table, a full or partial horizontal row of the data table, and a second subset of the set of data cells that is represented in the data table in an arrangement of more than one dimension.
